(19) United States
(12) Patent Application Publication
(10) Pub. No.: US 2025/0150844 A1
(43) Pub. Date: May 8, 2025

(54) RADIO BASE STATION AND TERMINAL

(71) Applicant: NTT DOCOMO, INC., Tokyo (JP)

(72) Inventors: Tatsuki Okuyama, Tokyo (JP); Satoshi Suyama, Tokyo (JP); Nobuhide Nonaka, Tokyo (JP)

(73) Assignee: NTT DOCOMO, INC., Tokyo (JP)

(21) Appl. No.: 18/836,564

(22) PCT Filed: Feb. 22, 2022
(86) PCT No.: PCT/JP2022/007165

§ 371 Date: Aug. 7, 2024

(51) Int. Cl. H04W 16/28; H04W 72/044; H04W 72/12

(52) U.S. Cl. CPC H04W 16/28; H04W 72/046; H04W 72/12

(57) ABSTRACT

A radio base station performs a beam search with a plurality of stages in which at least any of a beam width to be searched and the number of beam candidates to be searched is different, and transmits and receives data at a required rate. The radio base station performs the beam search including a first stage and a second stage after an end of the first stage having a beam width that is narrower than a beam width of the first stage and the number of beam candidates that is larger than the number of beam candidates of the first stage, starts transmitting and receiving the data immediately after the end of the first stage, when the required rate is a specified rate or less, and starts transmitting and receiving the data after an end of the second stage, when the required rate is more than the specified rate.

### TECHNICAL FIELD

The present disclosure relates to a radio base station and terminal that support beamforming.

### BACKGROUND ART

The 3rd Generation Partnership Project (3GPP) has prepared a specification for the 5th generation mobile communication system (also referred to as 5G, New Radio (NR), or Next Generation (NG)), and further a specification for a next-generation system referred to as Beyond 5G, 5G Evolution, or 6G is also being prepared.

3GPP Releases 15 and 16 specify beamforming utilizing Massive Multiple-Input Multiple-Output (MIMO) generating a beam with higher directivity by controlling radio signals transmitted from a plurality of antenna elements (for example, Non-Patent Literature 1).

In 6G, it is assumed that not only a radio base station but also a terminal (User Equipment, UE) can perform beamforming utilizing Massive MIMO. In addition, in 6G, a high frequency band such as a terahertz (THz) band is also assumed to be used. In this kind of high frequency band, narrow beams are formed using more antenna elements, which may increase the number of beam candidates.

### CITATION LIST

### Non-Patent Literature

Non-Patent Literature 1: 3GPP TS 38.212 V16.8.0, 3rd Generation Partnership Project; Technical Specification Group Radio Access Network; NR; Multiplexing and channel coding (Release 16), 3GPP, December 2021

### SUMMARY OF THE INVENTION

When a beam width is narrow and the number of beam candidates is large as described above, an increase in the required time and processing load of the beam search is a concern.

Therefore, the following disclosure has been made in view of this kind of situation, and an object of the disclosure is to provide a radio base station and terminal capable of implementing an efficient beam search even if a beam width is narrow and the number of beam candidates is large.

One aspect of the present disclosure provides a radio base station (NodeB 100) including: a control unit (control unit 270) that performs a beam search with a plurality of stages in which at least any of a beam width to be searched and the number of beam candidates to be searched is different; and a transmission and reception unit (data transmission and reception unit 260) that transmits and receives data at a required rate, in which the control unit performs the beam search including a first stage and a second stage after an end of the first stage having a beam width that is narrower than a beam width of the first stage and the number of beam candidates that is larger than the number of beam candidates of the first stage, and the transmission and reception unit starts transmitting and receiving the data immediately after the end of the first stage, when the required rate is a specified rate or less, and starts transmitting and receiving the data after an end of the second stage, when the required rate is more than the specified rate.

One aspect of the present disclosure provides a radio base station (NodeB 100) including: a control unit (control unit 270) that performs a beam search with a plurality of stages in which at least any of a beam width to be searched and the number of beam candidates to be searched is different, in which the control unit performs the beam search including a first stage and a second stage after an end of the first stage having a beam width that is narrower than a beam width of the first stage and the number of beam candidates that is larger than the number of beam candidates of the first stage, and the control unit performs scheduling of a user in the first stage or the second stage.

One aspect of the present disclosure provides a terminal (UE 200) including: a control unit (control unit 270) that performs a beam search with a plurality of stages in which at least any of a beam width to be searched and the number of beam candidates to be searched is different; and a transmission and reception unit (data transmission and reception unit 260) that transmits and receives data at a required rate, in which the control unit performs the beam search including a first stage and a second stage after an end of the first stage having a beam width that is narrower than a beam width of the first stage and the number of beam candidates that is larger than the number of beam candidates of the first stage, and the transmission and reception unit starts transmitting and receiving the data immediately after the end of the first stage, when the required rate is a specified rate or less, and starts transmitting and receiving the data after an end of the second stage, when the required rate is more than the specified rate.

One aspect of the present disclosure provides a terminal (UE 200) including: a control unit (control unit 270) that performs a beam search with a plurality of stages in which at least any of a beam width to be searched and the number of beam candidates to be searched is different, in which the control unit performs the beam search including a first stage and a second stage after an end of the first stage having a beam width that is narrower than a beam width of the first stage and the number of beam candidates that is larger than the number of beam candidates of the first stage, and the control unit performs scheduling of a user in the first stage or the second stage.

### BRIEF DESCRIPTION OF THE DRAWINGS

FIG. 1 is an overall schematic configuration diagram of a radio communication system 10 according to the present embodiment.

FIG. 2 is a diagram showing a frequency range used in the radio communication system 10.

FIG. 3 is a diagram showing configuration examples of radio frames, subframes, and slots used in the radio communication system 10.

FIG. 4 is a functional block diagram of a NodeB 100 and UE 200.

FIG. 5 is a diagram showing a configuration example of the beam transmission and beam search divided into a plurality of stages (N stages).

FIG. 6 is a diagram showing the beam search and communication start flow according to Operation Example 1.

FIG. 7 is a diagram showing the flow of the beam search and user scheduling according to Operation Example 2.

FIG. 8 is a diagram showing an example of utilization of user information according to Operation Example 3.

FIG. 9 is a diagram showing an example of a hardware configuration of the NodeB 100 and UE 200.

FIG. 10 is a diagram showing a configuration example of a vehicle 2001.

### DESCRIPTION OF EMBODIMENTS

An embodiment will be explained below with reference to the accompanying drawings. Note that the same or similar reference numerals have been attached to the same functions and configurations, and the description thereof will be omitted as appropriate.

### (1) Overall Schematic Configuration of Radio Communication System

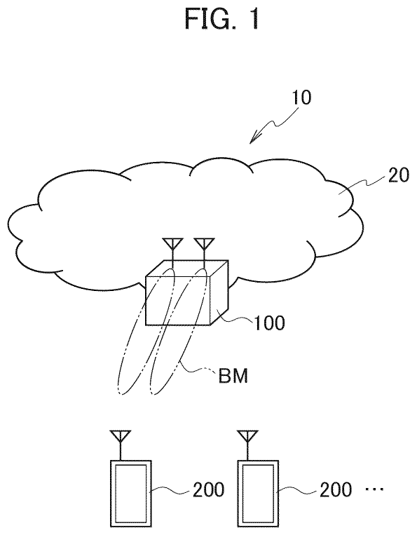

FIG. 1 is an overall schematic configuration diagram of a radio communication system 10 according to the present embodiment. The radio communication system 10 is compliant with a method referred to as Beyond 5G, 5G Evolution, or 6G (hereinafter referred to as 6G), and includes a Radio Access Network 20 (hereinafter referred to as RAN 20) and a terminal 200 (hereinafter referred to as UE 200, User Equipment, UE). The radio communication system 10 may be compliant with 5G New Radio (NR).

The RAN 20 includes a radio base station 100 (hereinafter referred to as NodeB 100). A specific configuration of the radio communication system 10 including the number of Nodes B and UEs is not limited to an example shown in FIG. 1.

The RAN 20 actually includes a plurality of RAN Nodes, specifically Nodes B, and is connected to a 6G-compliant core network (not shown). The RAN 20 and core network may simply be expressed as a “network”.

The NodeB 100 is a radio base station that is compliant with 6G and performs radio communication according to 5G with the UE 200. The NodeB 100 and UE 200 can support Massive Multiple-Input Multiple-Output (MIMO) generating an antenna beam (hereinafter referred to as beam BM) with higher directivity by controlling radio signals transmitted from a plurality of antenna elements, Carrier Aggregation (CA) bundling and using a plurality of Component Carriers (CCs), Dual Connectivity (DC) simultaneously communicating between the UE and each of the two NG-RAN Nodes, and the like.

The NodeB 100 can transmit a plurality of beams BM with different transmission directions (may simply be referred to as direction, or emission direction or coverage) by space division and time division. The NodeB 100 may transmit the plurality of beams BM simultaneously. In addition, not only the NodeB 100 but also the UE 200 can appropriately change the transmission direction, width (referred to as beam width), the number, and the like of the beams BM to support beamforming for forming a desired beam BM.

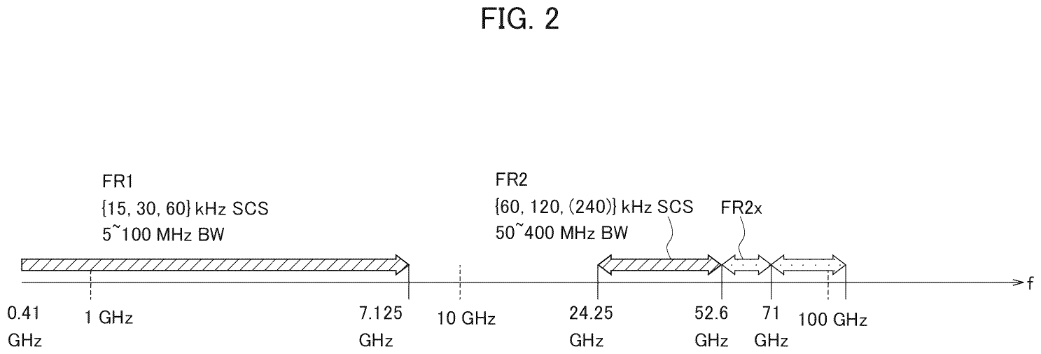

Further, the radio communication system 10 may support a plurality of frequency ranges (FRs). FIG. 2 shows frequency ranges used in the radio communication system 10.
FR 1:410 MHz to 7.125 GHZ
FR 2:24.25 GHz to 52.6 GHZ

In the FR 1, Sub-Carrier Spacing (SCS) of 15, 30, or 60 kHz is used and a bandwidth (BW) of 5 to 100 MHz may be used. The FR 2 is higher than the FR 1, an SCS of 60 or 120 kHz (240 kHz may be included) is used and a bandwidth (BW) of 50 to 400 MHz may be used.

In addition, the radio communication system 10 may also support a higher frequency band than the frequency band of the FR 2. Specifically, the radio communication system 10 may support a frequency band of more than 52.6 GHZ and 114.25 GHZ or less and/or a frequency band between the FR 1 and FR 2. The frequency band of more than 100 GHz may be referred to as a terahertz (THz) band.

The SCS may be interpreted as numerology. The numerology is defined in 3GPP TS38.300 and corresponds to one subcarrier interval in a frequency domain, for example.

In addition, the radio communication system 10 supports a frequency band which is higher than the frequency band of the FR 2. Specifically, the radio communication system 10 supports a frequency band of more than 52.6 GHZ and 71 GHZ or less. This kind of high frequency band may be referred to as “FR 2x” for convenience. Further, the FR 2 may include FR 2-1 (24.25 to 52.6 GHz) and FR 2-2 (52.6 to 71 GHZ).

When a high frequency band such as the FR 2x is used, Cyclic Prefix-Orthogonal Frequency Division Multiplexing (CP-OFDM)/Discrete Fourier Transform—Spread (DFT-S-OFDM) with larger Sub-Carrier Spacing (SCS) may be applied.

In addition, in the high frequency band such as the FR 2x described above, an increase in phase noise between carriers becomes a problem. For this reason, it may be necessary to apply a larger (wider) SCS or a single-carrier waveform.

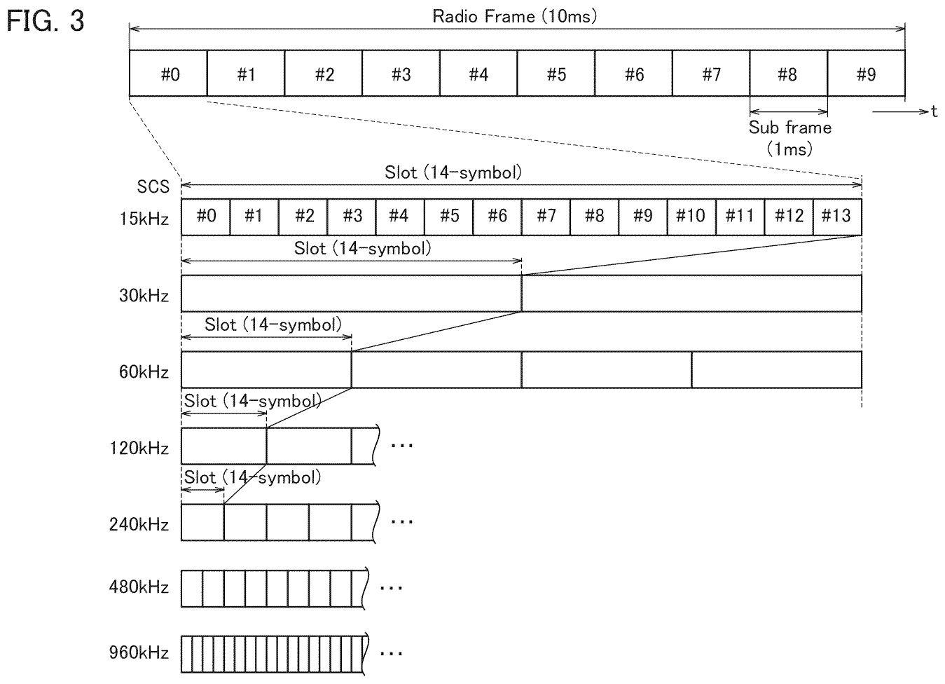

The larger the SCS, the shorter a symbol/Cyclic Prefix (CP) period and slot period (if 14 symbols/slot configuration is maintained). FIG. 3 shows configuration examples of radio frames, subframes, and slots used in the radio communication system 10. If the 14 symbols/slot configuration is maintained, the larger (wider) the SCS, the shorter the symbol period (and slot period).

Note that a time direction (t) shown in FIG. 3 may be referred to as a time region, time domain, symbol period, symbol time, or the like. Further, a frequency direction may be referred to as a frequency region, frequency domain, resource block, resource block group, subcarrier, Bandwidth part (BWP), subchannel, common frequency resource, or the like.

Further, the number of symbols constituting one slot does not necessarily have to be 14 (for example, 28, 56 symbols). In addition, the number of slots per subframe may vary depending on the SCS.

In addition, in a case where the high frequency band such as the FR 2x or terahertz band is supported, it is necessary to generate a narrower beam by using a massive antenna having a large number of antenna elements in order to respond to a wide bandwidth and a large propagation loss. That is, a large number of beams are required to cover a certain geographical area.

In the case of 3GPP Release 15 (FR 2), the maximum number of beams used for SSB (SS/PBCH Block) transmission consisting of a synchronization signal (SS) and a downlink physical broadcast channel (PBCH: Physical Broadcast CHannel) is 64, but the maximum number of beams (the number of beam candidates) may be extended to cover the certain geographical area with narrow beams, for example. In this case, the number of SSBs may be 64 or more.

Further, in the radio communication system 10, the beam search (may be read as beam transmission) can be performed by dividing the search into a plurality of stages. In the radio communication system 10, although it is possible to support the high frequency band such as the FR 2x or terahertz band, a beam BM having a high power density and a narrow beam width is required to ensure a certain radio communication quality in the high frequency band, and the number of beam candidates may increase as described above.

Therefore, in order to enhance the efficiency of the beam search, the beam search may be divided into a plurality of stages (N stages). Further, in each stage of the beam search, beams BM with different beam widths and/or a different number of beam candidates may be used.

### (2) Functional Block Configuration of Radio Communication System

Next, a functional block configuration of the radio communication system 10 will be described. Specifically, functional block configurations of the NodeB 100 and UE 200 will be described.

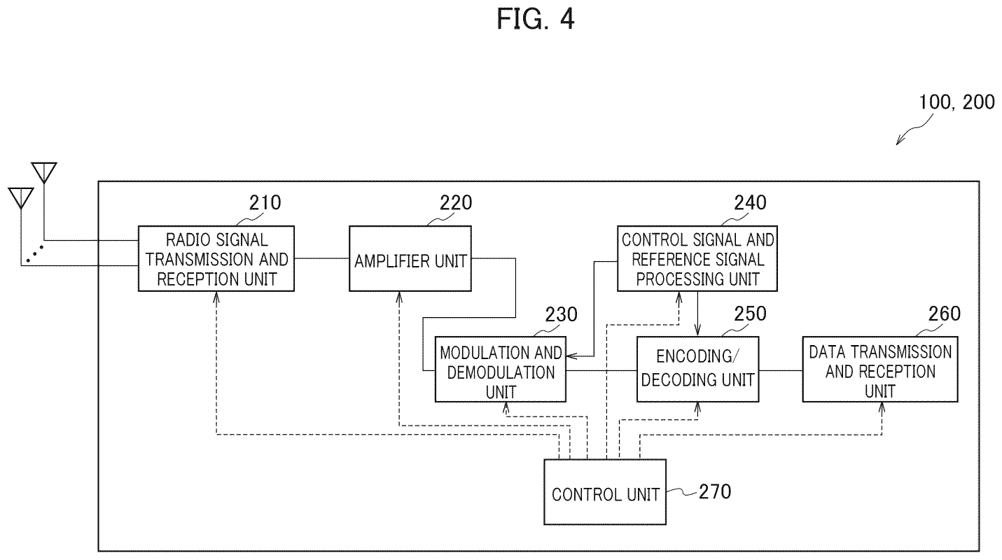

FIG. 4 is a functional block diagram of the NodeB 100 and UE 200. The NodeB 100 will be described below.

As shown in FIG. 4, the NodeB 100 includes a radio signal transmission and reception unit 210, an amplifier unit 220, a modulation and demodulation unit 230, a control signal and reference signal processing unit 240, an encoding/decoding unit 250, a data transmission and reception unit 260, and a control unit 270.

The radio signal transmission and reception unit 210 transmits and receives a radio signal compliant with 6G. The radio signal transmission and reception unit 210 may support Massive MIMO, CA bundling and using a plurality of CCs, and DC communicating simultaneously between the UE and each of the two RAN Nodes.

The radio signal transmission and reception unit 210 may transmit a radio signal such as an SSB transmitted from the NodeB 100 using the beam BM (see FIG. 1). The beam BM may be a directional beam or a non-directional beam.

Further, a width of the beam BM may be changed as appropriate. When the high frequency band such as the FR 2x or terahertz band is used, a narrower beam width may be used than when a frequency band of the FR 2 or less is used, for example. The beam width may be interpreted as a range within which certain or greater reception quality can be obtained when radio waves emitted from an antenna (may be referred to as Transmission Reception Point (TRP)) are received. For the beam width, a horizontal direction may be used as a reference or a vertical direction may be used as a reference.

The direction and beam width of the beam BM can be changed depending on antenna elements to be used and/or the number of antenna elements. The beam width may be interpreted in the same way as the number of antenna elements (or the number of antennas (TRPs)) used to generate the beam BM.

The maximum number of beams used for SSB transmission may be 64, for example, or the maximum number of beams may be increased to cover a certain geographical area with narrow beams. In this case, the number of SSBs may be 64 or more, and values at or after #64 may be used for an index for identifying an SSB (SSB index).

The amplifier unit 220 is constituted by a Power Amplifier (PA)/a Low Noise Amplifier (LNA), or the like. The amplifier unit 220 amplifies a signal output from the modulation and demodulation unit 230 to have a predetermined power level. Further, the amplifier unit 220 amplifies an RF signal output from the radio signal transmission and reception unit 210.

The modulation and demodulation unit 230 performs data modulation/demodulation, transmission power configuration, resource block allocation, and the like for each predetermined communication destination (NodeB 100 or the like). In the modulation and demodulation unit 230, Cyclic Prefix-Orthogonal Frequency Division Multiplexing (CP-OFDM)/Discrete Fourier Transform-Spread (DFT-S-OFDM) may be applied. Further, DFT-S-OFDM may be used not only for the uplink (UL) but also for the downlink (DL).

The control signal and reference signal processing unit 240 performs processing for various control signals transmitted and received by the UE 200 and processing for various reference signals transmitted and received by the UE 200.

Specifically, the control signal and reference signal processing unit 240 receives various control signals transmitted from the NodeB 100 via a predetermined control channel, for example, control signals of a radio resource control layer (RRC). Further, the control signal and reference signal processing unit 240 transmits various control signals to the NodeB 100 via the predetermined control channel.

The control signal and reference signal processing unit 240 performs processing using Reference Signals (RSs) such as a Demodulation Reference Signal (DMRS), a Phase Tracking Reference Signal (PTRS), and the like. In a broad sense, the SSB may also be interpreted as a kind of reference signal.

A DMRS is a terminal-specific reference signal (a pilot signal) known between a base station and a terminal for estimating a fading channel used for data demodulation. The PTRS is a terminal-specific reference signal for the purpose of estimating phase noise, which becomes a problem in a high frequency band.

In addition to a DMRS and PTRS, the reference signals may include a Channel State Information-Reference Signal (CSI-RS), a Sounding Reference Signal (SRS), and a Positioning Reference Signal (PRS) for position information.

Further, the channel includes a control channel and data channel. The control channel may include a Physical Downlink Control Channel (PDCCH), a Physical Uplink Control Channel (PUCCH), a Random Access Channel (RACH), Downlink Control Information (DCI) including a Random Access Radio Network Temporary Identifier (RA-RNTI), and a Physical Broadcast Channel (PBCH). The control may mean various control signals transmitted via the control channel.

Further, the data channel includes a Physical Downlink Shared Channel (PDSCH), a Physical Uplink Shared Channel (PUSCH), and the like. The data may mean data transmitted via the data channel or user data.

A PUCCH may be interpreted as a UL physical channel used for transmission of Uplink Control Information (UCI). The UCI may be transmitted by means of either a PUCCH or PUSCH depending on a situation. The DCI may always be transmitted by means of a PDCCH and may not be transmitted via a PDSCH.

The UCI may include at least any of an ACK/NACK of a Hybrid automatic repeat request (HARQ), a scheduling request (SR) from the UE 200, and Channel State Information (CSI).

Further, the timing of transmitting the PUCCH and radio resources may be controlled by means of the DCI in the same way as the data channel.

The encoding/decoding unit 250 performs data division/connection, channel coding/decoding, and the like for each predetermined communication destination (NodeB 100 or another gNB).

Specifically, the encoding/decoding unit 250 divides the data output from the data transmission and reception unit 260 into predetermined sizes, and performs channel coding on the divided data. Further, the encoding/decoding unit 250 decodes the data output from the modulation and demodulation unit 230 and connects the decoded data.

The data transmission and reception unit 260 transmits and receives a Protocol Data Unit (PDU) and a Service Data Unit (SDU). Specifically, the data transmission and reception unit 260 performs assembly/disassembly and the like of PDUs/SDUs in a plurality of layers (a medium access control layer (MAC), a radio link control layer (RLC), and a packet data convergence protocol layer (PDCP), and the like). Further, the data transmission and reception unit 260 performs data error correction and re-transmission control based on a Hybrid automatic repeat request (ARQ).

Further, the data transmission and reception unit 260 can transmit and receive required rate data. In the present embodiment, the data transmission and reception unit 260 constitutes a transmission and reception unit. The required rate may be interpreted as a communication rate (transmission rate) of data (basically, user data) transmitted and/or received by the UE 200. The required rate may be expressed in units such as bits per second (bps).

If the required rate is a specified rate or less, the data transmission and reception unit 260 may start transmitting and receiving data immediately after the end of a first stage of the beam search. Meanwhile, if the required rate is more than the specified rate, the data transmission and reception unit 260 starts transmitting and receiving data after the end of a second stage of the beam search.

That is, the data transmission and reception unit 260 may change the number of stages to be performed from the first stage to any of a plurality of stages of the beam search depending on whether the required rate is high or low. Specifically, as the required rate increases, the number of stages of the beam search may increase (a stage may progress deeper from the first stage).

In the beam search with a plurality of stages, as a stage progresses deeper (becomes later) from the first stage, the beam width may be narrow and/or the number of beam candidates may increase.

The control unit 270 controls each functional block constituting the NodeB 100. In particular, in the present embodiment, the control unit 270 performs control on the beam search with a plurality of stages.

Specifically, the control unit 270 can perform the beam search with a plurality of stages in which at least any of the beam width to be searched and the number of beam candidates to be searched is different. The beam search may be interpreted as an operation of searching (finding) one or more beams BM transmitted from the UE 200.

More specifically, the control unit 270 may perform the beam search including the first stage and the second stage after the end of the first stage which has a narrower beam width or a larger number of beam candidates than that in the first stage. The number of stages of the beam search may be three or more. If the number of stages is three or more, it is preferable that a third stage has a narrower beam width or a larger number of beam candidates than that in the second stage.

The beam width may be interpreted as a range in a beam search target horizontal direction and/or vertical direction. Further, the number of beam candidates may be interpreted as the number of beam search target beams BM. The number of beam candidates may increase as the beam width decreases.

Further, the control unit 270 may combine the scheduling of a user (UE 200) with the beam search with a plurality of stages. That is, the search (determination) of the beam BM by the beam search and the scheduling of the user may be determined simultaneously. The scheduling of the user may be interpreted as allocating resources in the time direction and/or frequency direction to a specific user (UE).

Specifically, the control unit 270 may perform the scheduling of the user in the first or second stage of the beam search. The control unit 270 may determine the number of users (UEs) linked to identification information (beam ID) of each beam in the first stage, and determine a scheduling target user (may include the number of users) while narrowing down the beam search range in the second stage and thereafter, for example. The upper limit of the number of scheduling target users may be specified in advance by a 3GPP specification, or an arbitrary value may be set in advance therefor. Alternatively, the upper limit of the number of scheduling target users may be dynamically changed depending on a state of the radio communication system 10 or the like. The change may be implemented by signaling by a higher layer (for example, RRC) or a lower layer (for example, MAC-CE).

Further, the control unit 270 may change the beam width to be searched or the number of beam candidates to be searched according to the required rate or the number of users. The control unit 270 may set the number of stages of the beam search to be larger than the standard number for a user with a high required rate, and may set the number of stages of the beam search to be less than the standard number for a user with a low required rate, for example.

Alternatively, the control unit 270 may group a plurality of users with high required rates and a plurality of users with low required rates (the number of groups may be more), and change the beam width to be searched or the number of beam candidates to be searched or change the number of stages of the beam search, based on the summed required rate for each group.

Further, in the first or second stage of the beam search, the control unit 270 may change at least any of the order of a beam search direction and a search target frequency band. The control unit 270 may determine the priority of the beam search direction according to an environment of a propagation path with the UE 200, for example. An example of the search direction is the horizontal direction priority or the vertical direction priority.

Alternatively, the control unit 270 may divide a frequency band to be used into a plurality of sub-bands in each stage of the beam search, based on frequency characteristics of the frequency band, and perform search and formation of a beam for each sub-band.

In addition, the control unit 270 may be controlled so as to form a so-called grating beam by using some antenna elements, and to transmit, in a second stage and thereafter of the beam search, a grating beam covering a direction different from the main beam used in the first stage.

Although the main functions of the NodeB 100 have been described above, the UE 200 may substantially have the same functions as the NodeB 100 for search and formation/transmission of a beam.

### (3) Operation of Radio Communication System

Next, an operation of the radio communication system 10 will be described. Specifically, the operation for the stagewise beam search will be described.

As described above, beamforming utilizing Massive MIMO is used in the radio communication system 10. In particular, not only the radio base station but also the terminal (mobile stations) can perform beamforming. Further, in order to support a high frequency band such as a terahertz band, narrow (thin) beams using more antenna elements are required, and the number of beam candidates may increase further.

In this kind of radio communication system 10, an efficient beam search is essential. Therefore, the beam search is divided into a plurality of stages (N stages).

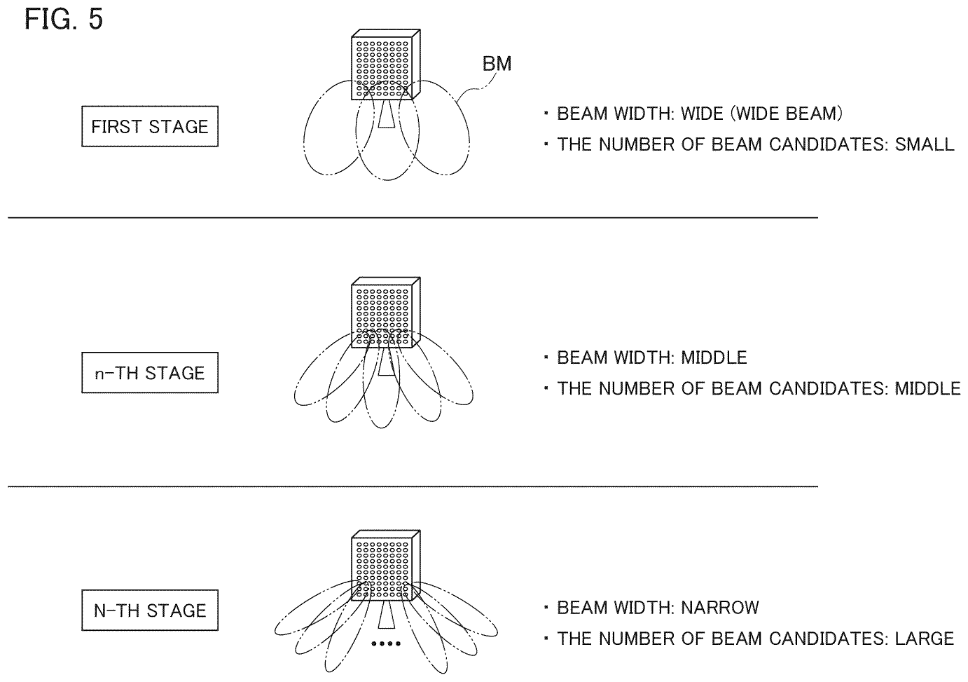

FIG. 5 shows a configuration example of the beam transmission and beam search divided into a plurality of stages (N stages). In the example shown in FIG. 5, the beam search (and beam transmission, hereinafter the same) may be performed by being divided into N stages from a first stage.

In the first stage (initial stage), a width of the beam BM (hereinafter referred to as beam width) may be large. In the first stage, a so-called wide beam may be used, for example. It is sufficient if the width of the wide beam is larger than the beam width used in an n-th stage after the first stage. The wide beam may be basically a directional beam, but it may also be a non-directional beam. In addition, the number of beam candidates in the first stage may be the smallest among those in the plurality of stages.

In the n-th stage (may be a next stage after the first stage or a next stage after the stage and thereafter), the level of the beam width may be a middle level and the level of the number of beam candidates may be a middle level.

In an N-th stage (may be a next stage after the n-th stage or a next stage after the stage and thereafter), the beam width may be narrower and the number of beam candidates may be larger than those in the n-th stage.

In other words, it is preferable that the beam width satisfies the relationship of the first stage≥the n-th stage≥the N-th stage. Further, it is preferable that the number of beam candidates satisfies the relationship of the first stage≤the n-th stage≤the N-th stage.

A value of N is not particularly limited, but may be changed in consideration of an installation status of the radio base station (cell coverage), a communication environment, and the like. In addition, as described later, a value of N for starting communication may be dynamically controlled in accordance with the communication environment, and the like. This may achieve reduction in time required for the beam search and enhancement of the system performance.

As described above, the NodeB 100 and UE 200 can support beamforming, but in the following, the NodeB 100 or UE 200 is appropriately described as a radio communication device.

### (3.1) Operation Example 1

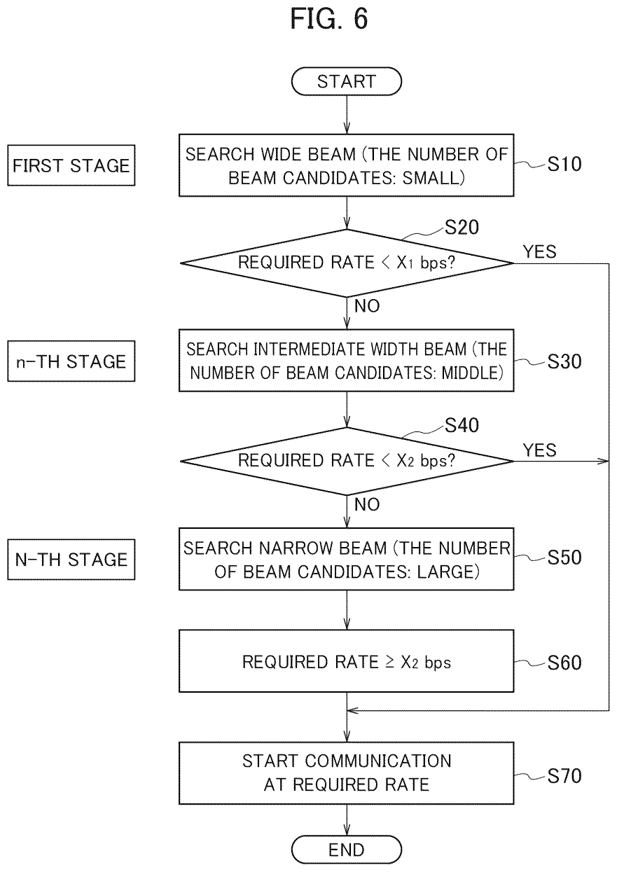

Operation Example 1 relates to dynamic control of the number of beam candidates according to the required rate. FIG. 6 shows the beam search and communication start flow according to Operation Example 1.

In the operation example, the beam search divided into the first stage to the N-th stage as shown in FIG. 5 may be performed. As shown in FIG. 6, the radio communication device (NodeB 100 and UE 200) performs the beam search for the wide beam as the first stage (S10). In the first stage, the number of beam candidates may be small.

The radio communication device determines whether the required rate is less than a specified rate (here, X₁ bps) (S20). If the required rate is less than X₁ bps, the radio communication device may start communication at the required rate (S70).

If the required rate is X₁ bps or more, the radio communication device performs the beam search for an intermediate width beam in the n-th stage (S30). The intermediate width beam has a narrower beam width than the wide beam. In the n-th stage, the number of beam candidates may be larger than that in the first stage and smaller than that in the N-th stage.

The radio communication device determines whether the required rate is less than a specified rate (here, X₂ bps, X₁<X₂) (S40). If the required rate is less than X₂ bps, the radio communication device may start communication at the required rate (S70).

If the required rate is X₂ bps or more, the radio communication device performs the beam search for a narrow beam in the N-th stage (S50, S60). The narrow beam has a narrower beam width than the intermediate width beam. In the N-th stage, the number of beam candidates may be larger than that in the n-th stage. As a result of the beam search for the narrow beam, the radio communication device may start communication at the required rate using the searched beam BM (S70).

In this way, a value of n for starting communication may be changed according to the required rate. If the required rate is low and is less than a predetermined value, communication may be started when n=1 or 2, for example. Meanwhile, if the required rate is high and is a predetermined value or more, communication may be started when n=4 or 5.

That is, if the required rate is high, a large number of beams BM may be allocated to one user (for multistream transmission), and if the required rate is low, a small number of beams BM may be allocated.

The operation example may be changed as follows. Specifically, in the n-th stage, the beam search direction may be limited to a certain direction (range) including an incoming direction of the beam BM, based on a result of the beam search in a (n−1)th stage, instead of the beam search in all directions.

In addition, although two or more beams BM (for example, L beams) are used for communication at the required rate, the feedback is performed with only one of the beams BM, and beams BM other than the direction of the beam BM used for the feedback may be freely determined.

In addition, not only the beam BM determined in the n-th stage but also a beam BM in the periphery of the beam may be emitted, and the number and/or direction of the target beam BM may be determined using a CSI-RS.

### (3.2) Operation Example 2

In Operation Example 2, user scheduling is combined with the beam search in Operation Example 1. Specifically, user (UE) scheduling is performed at the same time as when the beam search of N stages is performed.

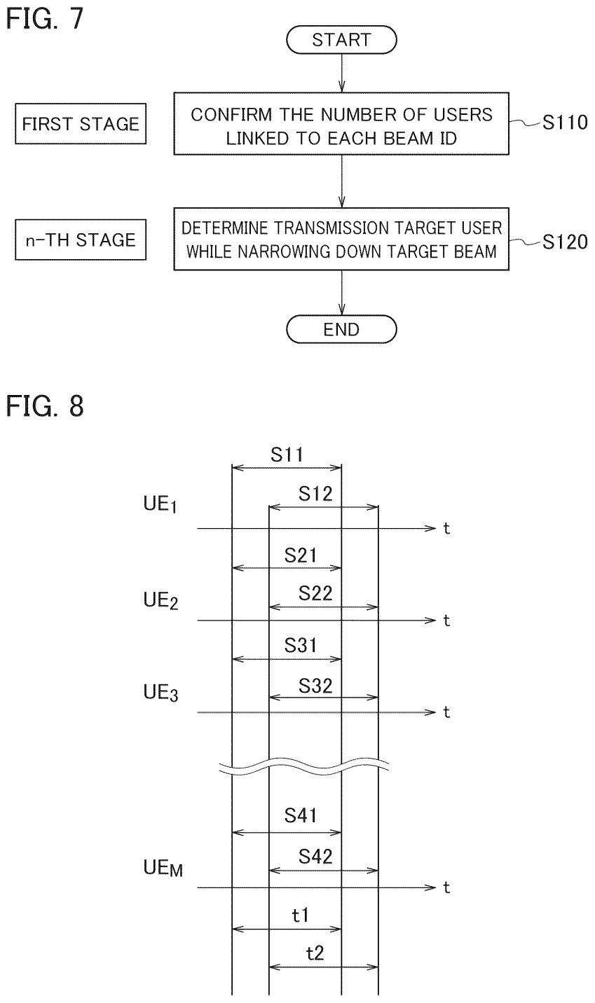

FIG. 7 shows the flow of the beam search and user scheduling according to Operation Example 2. As shown in FIG. 7, in the first stage (or may be the (n−1)th stage), the radio communication device confirms the number of users linked to each beam ID (S110). The upper limit of the number of users may be set in advance according to a specification of 3GPP, or may be set dynamically according to a message of a higher layer, for example.

The upper limit of the number of users may mean the number of users (UEs) finally selected and communicated in the entire radio communication system 10. The upper limit of the number of users may be determined based on a unit (for example, cell, radio base station, or the like) in which the radio communication system 10 is physically or logically divided. Further, as described above, the upper limit of the number of users may be dynamically changed according to a state of the radio communication system 10 or the like.

In the n-th stage, the radio communication device determines a transmission target user while narrowing down the beam search (S120). Specifically, based on the number of users linked to each beam ID, the radio communication device may limit a search target beam BM (for example, a beam direction with a large number of users may be targeted), and determine a user allocated to the beam BM.

In the (n−1)th stage, the following operation may be performed.
(i) A beam ID of “0” users is omitted (ignored).
(ii) If the number of users is two or more, any one (one user) of the users is selected (for example, select user with high received power).

After performing at least any of (i) and (ii), in the (n−1)th stage, the beam width to be searched may be reduced and processing in the n-th stage (S120 in FIG. 7) may be performed.

The operation example may be changed as follows.
(Modified Example 1): If a beam BM to which two or more users are linked and a beam BM to which only one user is linked are present in the n-th stage, the beam BM to which only one user is linked may be prioritized. This can reduce user scheduling processing.
(Modified Example 2): In the n-th stage, the number of selected users may be allowed to be more than one. This may cause an interference problem between users, but since the upper limit of the number of users is reached early, a value of n can be reduced.

### (3.3) Operation Example 3

In Operation Example 3, fixed time information for a user (UE) (hereinafter referred to as user information) is utilized in the beam search from the first stage to the N-th stage. FIG. 8 shows an example of utilization of user information according to Operation Example 3.

As shown in FIG. 8, in the beam search, individual pieces of information (S11, S12, S21, S22, S31, S32, S41, and S42) of user units (UE₁ to UE_{M}) at a fixed time (t1, t2) may be combined with information obtained by summing the individual pieces of information of the users for utilization.
(Example 1): Performance in user units may be maximized using user individual information. Specifically, if there are many high-rate users, a value of n indicating the number of stages of the beam search may be large, and alternatively if there are many low-rate users, a value of n may be small.
(Example 2): The system capacity may be maximized as a group by using the information obtained by summing the individual pieces of information of the users. Operation Example 2 may be applied to a group of high-rate users, and for a group of low-rate users, as described in Modified Example 2 of Operation Example 2, in the n-th stage, the number of selected users may be allowed to be more than one, for example. This can enhance the efficiency of the beam search.

It should be noted that the user scheduling using the user individual information and the user scheduling using the information obtained by summing the pieces of individual information of the users described above may be applied either only or in combination.

### (3.4) Operation Example 4

Operation Example 4 relates to control for a beam search method. In the beam search from the first stet to the N-th stage, the following control may be additionally performed.

### (Example 1): Controlling Priority of Beam Search Direction According to Propagation Environment

The radio base station (NodeB 100) may prioritize the search in the horizontal direction, and the terminal (UE 200) may detect a direction of the terminal and prioritize the search in either the vertical or horizontal direction, for example.

### (Example 2): Beam Search Considering Frequency Characteristics

In each search stage, a frequency band may be divided into sub-bands in consideration of the phase shift for each subcarrier (SC) and the beam BM may be determined for each sub-band.

### (Example 3): Enhancing Search Efficiency Utilizing Grating Beam

A grating beam may be formed by conducting a portion of an antenna element, and a grating beam may be applied which covers a direction in which the main beam is not facing in the (n−1)th stage, for example.

### (4) Operation and Effect

According to the above-described embodiment, the following operation and effects can be obtained. Specifically, the NodeB 100 and UE 200 can perform the beam search with a plurality of stages in which the beam width and the number of beam candidates are different, start the communication, that is, data transmission and reception immediately after the end of the n-th stage, if the required rate is a specified rate or less, and start data transmission and reception after the end of the N-th stage, if the required rate is more than the specified rate, for example.

Further, the NodeB 100 and UE 200 can perform user scheduling in the n-th stage or the N-th stage, for example.

For this reason, even if a high frequency band such as a terahertz band is used, the beam width is narrow, and the number of beam candidates is large, communication can be started or user scheduling can be performed while dividing the beam search into a plurality of stages, and therefore the efficient beam search can be implemented. This can avoid an increase in the required time and processing load of the beam search.

In the present embodiment, the NodeB 100 may change the beam width to be searched or the number of beam candidates to be searched in accordance with the required rate or the number of users. Therefore, it is possible to select an appropriate beam BM in accordance with the required rate or the number of users, and to implement the further efficient beam search.

In the present embodiment, the NodeB 100 and UE 200 may change at least any of the order of the beam search direction and a search target frequency band in the n-th stage or the N-th stage of the beam search, for example. This enables selection of an appropriate beam BM according to a propagation environment or frequency characteristics of a frequency band to be used, and implementation of the further efficient beam search.

### (5) OTHER EMBODIMENTS

Although the embodiment has been described above, it is obvious to those skilled in the art that the present invention is not limited to the description of the embodiment and that various modifications and improvements thereof are possible.

In the above-described embodiment, the beam search with a plurality of stages in which the beam width and the number of beam candidates are different is performed, but the beam search with a plurality of stages in which either one of the beam widths and the number of beam candidates is different may be performed. In the first stage and the n-th stage, the beam widths may be different, but the number of beam candidates may be the same, for example.

In the above description, the following terms may be used interchangeably: “precoding”, “precoder”, “weight (precoding weight)”, “Quasi-Co-Location (QCL)”, “Transmission Configuration Indication state (TCI state)”, “spatial relation”, “spatial domain filter”, “transmission power”, “phase rotation”, “antenna port”, “antenna port group”, “layer”, “the number of layers”, “rank”, “resource”, “resource set”, “resource group”, “beam”, “beam width”, “beam angle”, “antenna”, “antenna element”, “panel”, and the like.

In addition, the terms configure, activate, update, indicate, enable, specify, and select may be interchangeably read. Similarly, link, associate, correspond, and map may be interchangeably read, and allocate, assign, monitor, and map may be also interchangeably read.

In addition, specific, dedicated, UE-specific, and UE-dedicated may be interchangeably read. Similarly, common, shared, group-common, UE-common, and UE-shared may be interchangeably read.

The block diagram (FIG. 4) used in the description of the above-described embodiment illustrates blocks in units of functions. Those functional blocks (components) can be realized by any combination of at least one of hardware and software. A realization method for each functional block is not particularly limited. That is, each functional block may be realized by using one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that makes a transmitting function work may be called a transmitting unit or a transmitter. For any of the above, as described above, the realization method is not particularly limited.

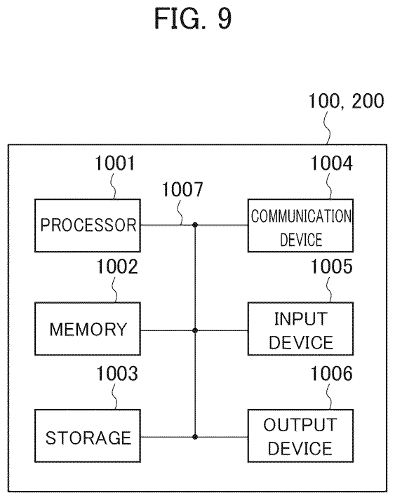

Further, the above-described NodeB 100 and UE 200 (the device) may function as a computer that performs processing of a radio communication method of the present disclosure. FIG. 9 is a diagram illustrating an example of a hardware configuration of the device. As illustrated in FIG. 9, the device may be configured as a computer device including a processor 1001, a memory 1002, a storage 1003, a communication device 1004, an input device 1005, an output device 1006, a bus 1007, and the like.

Furthermore, in the following description, the term “device” can be read as meaning circuit, device, unit, or the like. The hardware configuration of the device may include one or more devices illustrated in the figure or may not include some of the devices.

Each of the functional blocks of the device (FIG. 4) is implemented by means of any of hardware elements of the computer device or a combination of the hardware elements.

Each function in the device is realized by loading predetermined software (programs) on hardware such as the processor 1001 and the memory 1002 so that the processor 1001 performs arithmetic operations to control communication via the communication device 1004 and to control at least one of reading and writing of data on the memory 1002 and the storage 1003.

The processor 1001 operates, for example, an operating system to control the entire computer. The processor 1001 may be configured with a central processing unit (CPU) including interfaces with peripheral devices, control devices, arithmetic devices, registers, and the like.

Moreover, the processor 1001 reads a program (program code), a software module, data, and the like from at least one of the storage 1003 and the communication device 1004 into the memory 1002, and executes various processes according to these. As the program, a program causing the computer to execute at least part of the operation described in the above embodiment is used. Alternatively, various processes described above may be executed by one processor 1001 or may be executed simultaneously or sequentially by two or more processors 1001. The processor 1001 may be implemented by using one or more chips. Alternatively, the program may be transmitted from a network via a telecommunication line.

The memory 1002 is a computer readable recording medium and may be configured, for example, with at least one of a Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), and the like. The memory 1002 may store therein programs (program codes), software modules, and the like that can execute the method according to one embodiment of the present disclosure.

The storage 1003 is a computer readable recording medium. Examples of the storage 1003 include at least one of an optical disk such as Compact Disc ROM (CD-ROM), a hard disk drive, a flexible disk, a magneto-optical disk (for example, a compact disk, a digital versatile disk, Blu-ray (registered trademark) disk), a smart card, a flash memory (for example, a card, a stick, a key drive), a floppy (registered trademark) disk, a magnetic strip, and the like. The storage 1003 may be referred to as an auxiliary storage device. The recording medium may be, for example, a database including at least one of the memory 1002 and the storage 1003, a server, or other appropriate medium.

The communication device 1004 is hardware (transmission/reception device) capable of performing communication between computers via at least one of a wired network and a wireless network. The communication device 1004 is also referred to as, for example, a network device, a network controller, a network card, a communication module, and the like.

The communication device 1004 may include a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may have an integrated configuration (for example, a touch screen).

Also, the respective devices such as the processor 1001 and the memory 1002 are connected to each other with the bus 1007 for communicating information. The bus 1007 may be constituted by a single bus or may be constituted by different buses for each device-to-device.

Further, the device may be configured to include hardware such as a microprocessor, a Digital Signal Processor (DSP), an Application Specific Integrated Circuit (ASIC), a Programmable Logic Device (PLD), and a Field Programmable Gate Array (FPGA). Some or all of these functional blocks may be realized by means of this hardware. For example, the processor 1001 may be implemented by using at least one of the above-described items of hardware.

Further, notification of information is not limited to that in the aspect/embodiment described in the present disclosure, and may be performed by using other methods. For example, notification of information may be performed by physical layer signaling (for example, Downlink Control Information (DCI), Uplink Control Information (UCI)), higher layer signaling (for example, RRC signaling, Medium Access Control (MAC) signaling, broadcast information (Master Information Block (MIB), System Information Block (SIB)), other signals, or a combination thereof. The RRC signaling may also be referred to as an RRC message, for example, or may be an RRC Connection Setup message, an RRC Connection Reconfiguration message, or the like.

Each aspect/embodiment described in the present disclosure may be applied to at least one of Long Term Evolution (LTE), LTE-Advanced (LTE-A), SUPER 3G, IMT-Advanced, the 4th generation mobile communication system (4G), the 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), a system using any other appropriate system, and a next-generation system that is expanded based on these. Further, a plurality of systems may be combined (for example, a combination of at least one of LTE and LTE-A with 5G) and applied.

The order of the processing procedures, sequences, flowcharts, and the like of each aspect/embodiment described in the present disclosure may be exchanged as long as there is no contradiction. For example, the methods described in the present disclosure present the elements of the various steps by using an exemplary order and are not limited to the presented specific order.

The specific operation that is performed by a base station in the present disclosure may be performed by its upper node in some cases. In a network constituted by one or more network nodes having a base station, it is obvious that the various operations performed for communication with the terminal may be performed by at least one of the base station and other network nodes other than the base station (for example, an MME, an S-GW, and the like may be considered, but there is not limited thereto). In the above, an example in which there is one network node other than the base station is explained; however, a combination of a plurality of other network nodes (for example, an MME and an S-GW) may be used.

Information and signals (information and the like) can be output from a higher layer (or lower layer) to a lower layer (or higher layer). These may be input and output via a plurality of network nodes.

The input/output information may be stored in a specific location (for example, a memory) or may be managed in a management table. The information to be input/output can be overwritten, updated, or added. The information may be deleted after outputting. The inputted information may be transmitted to another device.

The determination may be made by using a value (0 or 1) represented by one bit, by truth-value (Boolean: true or false), or by comparison of numerical values (for example, comparison with a predetermined value).

Each of the aspects/embodiment described in the present disclosure may be used separately or in combination, or may be switched in accordance with the execution. In addition, notification of predetermined information (for example, notification of “is X”) is not limited to being performed explicitly, and it may be performed implicitly (for example, without notifying the predetermined information).

Regardless of being referred to as software, firmware, middleware, microcode, hardware description language, or some other name, software should be interpreted broadly to mean instructions, an instruction set, code, a code segment, program code, a program, a subprogram, a software module, an application, a software application, a software package, a routine, a subroutine, an object, an executable file, an execution thread, a procedure, a function, and the like.

Further, software, instruction, information, and the like may be transmitted and received via a transmission medium. For example, when software is transmitted from a website, a server, or another remote source by using at least one of a wired technology (a coaxial cable, an optical fiber cable, a twisted pair cable, a Digital Subscriber Line (DSL), or the like) and a wireless technology (infrared light, microwave, or the like), then at least one of these wired and wireless technologies is included within the definition of the transmission medium.

Information, signals, or the like described in the present disclosure may be represented by using any of a variety of different technologies. For example, data, an instruction, a command, information, a signal, a bit, a symbol, a chip, or the like that may be mentioned throughout the above description may be represented by a voltage, a current, an electromagnetic wave, a magnetic field or magnetic particles, an optical field or photons, or any combination thereof.

It should be noted that the terms described in the present disclosure and terms necessary for understanding the present disclosure may be replaced with terms having the same or similar meanings. For example, at least one of a channel and a symbol may be a signal (signaling). A signal may also be a message. Further, a Component Carrier (CC) may be referred to as a carrier frequency, a cell, a frequency carrier, or the like.

The terms “system” and “network” used in the present disclosure can be used interchangeably.

Furthermore, information, parameters, and the like described in the present disclosure may be represented by an absolute value, may be represented by a relative value from a predetermined value, or may be represented by corresponding other information. For example, a radio resource may be indicated using an index.

Names used for the above parameters are not restrictive names in any respect. In addition, formulas and the like using these parameters may be different from those explicitly disclosed in the present disclosure. Since the various channels (for example, a PUCCH, a PDCCH, or the like) and information elements can be identified by any suitable names, the various names allocated to these various channels and information elements shall not be restricted in any way.

In the present disclosure, the terms such as “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. A base station may also be referred to with a term such as a macro cell, a small cell, a femtocell, or a pico cell.

A base station can accommodate one or more (for example, three) cells (also referred to as sectors). In a configuration in which a base station accommodates a plurality of cells, the entire coverage area of the base station can be divided into a plurality of smaller areas. In each of the smaller areas, a communication service can be provided by a base station subsystem (for example, a small base station for indoor use (Remote Radio Head: RRH)).

The term “cell” or “sector” refers to a part or all of the coverage area of at least one of a base station and a base station subsystem that performs a communication service in this coverage.

In the present disclosure, the terms such as “mobile station (Mobile Station: MS)”, “user terminal”, “user equipment (User Equipment: UE)”, and “terminal” can be used interchangeably.

A mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms by those skilled in the art.

At least one of a base station and a mobile station may be called a transmitting device, a receiving device, a communication device, or the like. Note that at least one of a base station and a mobile station may be a device mounted on a moving body, a moving body itself, or the like. The moving body may be a vehicle (for example, a car, an airplane, or the like), an unmanned moving body (a drone, a self-driving car, or the like), or a robot (manned type or unmanned type). At least one of a base station and a mobile station also includes a device that does not necessarily move during the communication operation. For example, at least one of a base station and a mobile station may be an Internet of Things (IoT) device such as a sensor.

Also, a base station in the present disclosure may be read as meaning a mobile station (user terminal, hereinafter, the same). For example, each aspect/embodiment of the present disclosure may be applied to a configuration in which communication between a base station and a mobile station is replaced with communication between a plurality of mobile stations (which may be called Device-to-Device (D2D), Vehicle-to-Everything (V2X), or the like). In this case, the mobile station may have the function of a base station. In addition, words such as “uplink” and “downlink” may also be read as meaning words corresponding to inter-terminal communication (for example, “side”). For example, an uplink channel, a downlink channel, or the like may be read as meaning a side channel (or a side link).

Similarly, the mobile station in the present disclosure may be read as meaning a base station. In this case, the base station may have the function of the mobile station.

A radio frame may be composed of one or more frames in the time domain. Each of the one or more frames in the time domain may be referred to as a subframe. A subframe may be further composed of one or more slots in the time domain. The subframe may be a fixed time length (for example, 1 ms) independent of the numerology.

The numerology may be a communication parameter applied to at least one of transmission and reception of a certain signal or channel. The numerology may indicate at least one of, for example, SubCarrier Spacing (SCS), bandwidth, symbol length, cyclic prefix length, Transmission Time Interval (TTI), the number of symbols per TTI, radio frame configuration, a specific filtering process performed by a transceiver in the frequency domain, a specific windowing process performed by a transceiver in the time domain, and the like.

A slot may be composed of one or more symbols (Orthogonal Frequency Division Multiplexing (OFDM)) symbols, Single Carrier Frequency Division Multiple Access (SC-FDMA) symbols, and the like) in the time domain. A slot may be a unit of time based on the numerology.

A slot may include a plurality of minislots. Each minislot may be composed of one or more symbols in the time domain. A minislot may be called a subslot. A minislot may be composed of fewer symbols than slots. A PDSCH (or PUSCH) transmitted in time units greater than the minislot may be referred to as a PDSCH (or PUSCH) mapping type A. A PDSCH (or PUSCH) transmitted using a minislot may be referred to as a PDSCH (or PUSCH) mapping type B.

Each of a radio frame, subframe, slot, minislot, and symbol represents a time unit for transmitting a signal. A radio frame, subframe, slot, minislot, and symbol may have respectively different names corresponding to them.

For example, one subframe may be called a transmission time interval (TTI), a plurality of consecutive subframes may be called a TTI, and one slot or one minislot may be called a TTI. That is, at least one of the subframe and TTI may be a subframe (1 ms) in the existing LTE, a period shorter than 1 ms (for example, 1 to 13 symbols), or a period longer than 1 ms. Note that, a unit representing TTI may be called a slot, a minislot, or the like instead of a subframe.

Here, a TTI refers to the minimum time unit of scheduling in radio communication, for example. For example, in the LTE system, the base station performs scheduling for allocating radio resources (frequency bandwidth, transmission power, and the like that can be used in each user terminal) to each user terminal in units of TTI. The definition of TTI is not limited to this.

A TTI may be a transmission time unit such as a channel-coded data packet (transport block), a code block, or a code word, or may be a processing unit such as scheduling or link adaptation. When a TTI is given, a time interval (for example, the number of symbols) in which a transport block, a code block, a code word, and the like are actually mapped may be shorter than TTI.

When one slot or one minislot is called a TTI, one or more TTIs (that is, one or more slots or one or more minislots) may be the minimum time unit of the scheduling. The number of slots (minislot number) constituting the minimum time unit of the scheduling may be controlled.

A TTI having a time length of 1 ms may be referred to as an ordinary TTI (TTI in LTE Rel. 8-12), a normal TTI, a long TTI, an ordinary subframe, a normal subframe, a long subframe, a slot, and the like. A TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, and the like) may be read as meaning a TTI having a time length exceeding 1 ms, and a short TTI (for example, shortened TTI) may be read as meaning a TTI having a TTI length of less than a TTI length of a long TTI and a TTI length of 1 ms or more.

A resource block (RB) is a resource allocation unit in the time domain and the frequency domain, and may include one or more consecutive subcarriers in the frequency domain. The number of subcarriers included in the RB may be the same regardless of the numerology, and may be 12, for example. The number of subcarriers included in the RB may be determined based on the numerology.

Further, the time domain of an RB may include one or more symbols, and may have a length of 1 slot, 1 minislot, 1 subframe, or 1 TTI. Each TTI, subframe, or the like may be composed of one or more resource blocks.

Note that, one or more RBs may be called a Physical Resource Block (PRB), a Sub-Carrier Group (SCG), a Resource Element Group (REG), a PRB pair, a RB pair, and the like.

A resource block may be configured by one or more Resource Elements (REs). For example, one RE may be a radio resource domain of one subcarrier and one symbol.

A Bandwidth Part (BWP) (which may be called a partial bandwidth or the like) may represent a subset of consecutive common resource blocks (RBs) for a certain numerology in a certain carrier. Here, the common RB may be specified by an index of the RB based on the common reference point of the carrier. A PRB may be defined in a certain BWP and numbered within that BWP.

A BWP may include a BWP for UL (UL BWP) and a BWP for DL (DL BWP). One or more BWPs may be configured in one carrier for the UE.

At least one of the configured BWPs may be active, and the UE does not have to expect to transmit and receive predetermined signals/channels outside the active BWP. Note that “cell”, “carrier”, and the like in this disclosure may be read as meaning “BWP”.

The above-described structures such as a radio frame, a subframe, a slot, a minislot, and a symbol are merely examples. For example, structures such as the number of subframes included in a radio frame, the number of slots per subframe or radio frame, the number of minislots included in a slot, the number of symbols and RBs included in a slot or minislot, the number of subcarriers included in RBs, and the number of symbols included in a TTI, a symbol length, the Cyclic Prefix (CP) length, and the like can be changed in various manner.

The terms “connected”, “coupled”, or any variations thereof mean any direct or indirect connection or coupling between two or more elements, and can include that one or more intermediate elements are present between two elements that are “connected” or “coupled” to each other. The coupling or connection between the elements may be physical, logical, or a combination thereof. For example, “connection” may be read as meaning “access”. In the present disclosure, two elements can be “connected” or “coupled” to each other by using at least one of one or more wires, one or more cables, and one or more printed electrical connections, and as some non-limiting and non-exhaustive examples, by using electromagnetic energy having wavelengths in the radio frequency domain, a microwave region, and a light (both visible and invisible) region, and the like.

A Reference Signal may be abbreviated as RS and may be called a Pilot according to applicable standards.

As used in the present disclosure, the phrase “based on” does not mean “based only on” unless explicitly stated otherwise. In other words, the phrase “based on” means both “based only on” and “based at least on”.

“Means” in the configuration of each device above may be replaced with “unit”, “circuit”, “device”, and the like.

Any reference to elements using a designation such as “first”, “second”, or the like used in the present disclosure generally does not limit the amount or order of those elements. Such designations can be used in the present disclosure as a convenient method to distinguish between two or more elements. Thus, the reference to the first and second elements does not imply that only two elements can be adopted, or that the first element has to precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive-OR.

Throughout the present disclosure, for example, during translation, if articles such as a, an, and the in English are added, the present disclosure may include that a noun following these articles is used in plural.

As used in this disclosure, the term “determining” may encompass a wide variety of actions. “determining” includes deeming that determining has been performed by, for example, judging, calculating, computing, processing, deriving, investigating, searching (looking up, search, inquiry) (for example, searching in a table, database, or another data structure), ascertaining, and the like. In addition, “determining” can include deeming that determining has been performed by receiving (for example, receiving information), transmitting (for example, transmitting information), inputting (input), outputting (output), access (accessing) (for example, accessing data in a memory), and the like. In addition, “determining” can include deeming that determining has been performed by resolving, selecting, choosing, establishing, comparing, and the like. That is, “determining” may include deeming that “determining” regarding some action has been performed. Moreover, “determining” may be read as meaning “assuming”, “expecting”, “considering”, and the like.

In the present disclosure, the wording “A and B are different” may mean “A and B are different from each other”. It should be noted that the wording may mean “A and B are each different from C”. Terms such as “separate”, “couple”, or the like may also be interpreted in the same manner as “different”.

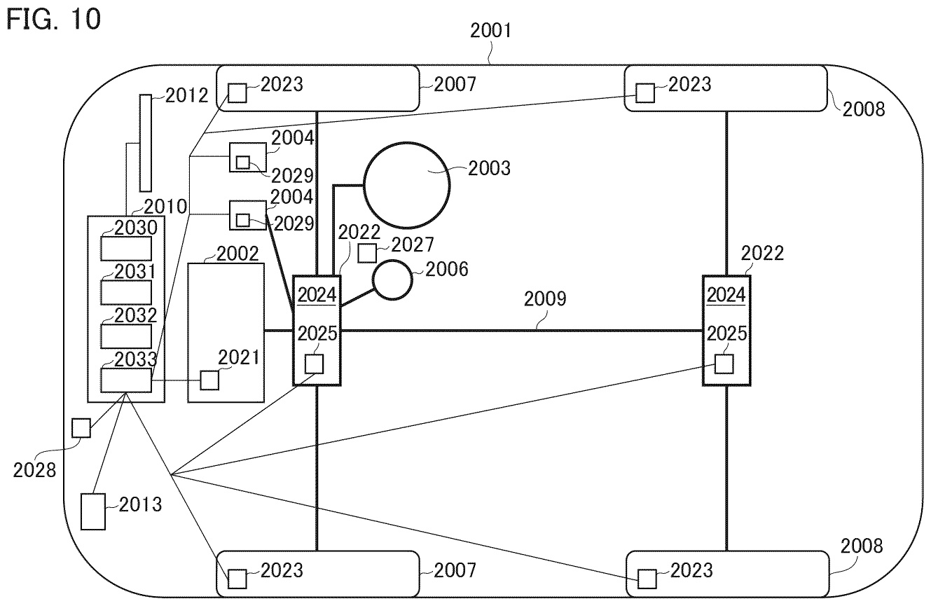

FIG. 10 shows a configuration example of a vehicle 2001. As shown in FIG. 10, the vehicle 2001 includes a drive 2002, a steering 2003, an accelerator pedal 2004, a brake pedal 2005, a shift lever 2006, left and right front wheels 2007, left and right rear wheels 2008, an axle 2009, an electronic controller 2010, various sensors 2021 to 2029, an information service unit 2012, and a communication module 2013.

Examples of the drive 2002 include, an engine, a motor, and a hybrid of an engine and a motor. The steering 2003 includes at least a steering wheel (also called a handle) and steers at least one of the front and rear wheels based on an operation of a steering wheel operated by a user. The electronic controller 2010 includes a microprocessor 2031, a memory (ROM, RAM) 2032, and a communication port (IO port) 2033. The electronic controller 2010 receives signals from various sensors 2021 to 2027 provided in the vehicle. The electronic controller 2010 may be called an ECU (Electronic Control Unit).

The signals from the various sensors 2021 to 2028 include a current signal from a current sensor 2021 for sensing current of a motor, a rotation speed signal of a front wheel and a rear wheel acquired by the speed sensor 2022, a pressure signal of a front wheel and a rear wheel acquired by an air pressure sensor 2023, a speed signal of a vehicle acquired by a speed sensor 2024, an acceleration signal acquired by an acceleration sensor 2025, an accelerator pedal pressed-amount signal acquired by an accelerator pedal sensor 2029, a brake pedal pressed-amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like.

The information service unit 2012 includes various devices such as a car navigation system, an audio system, a speaker, a television, and a radio for providing various information such as driving information, traffic information, and entertainment information, and one or more ECUs for controlling these devices. The information service unit 2012 provides various multimedia information and multimedia services to an occupant of the vehicle 1 by using information acquired from an external device through a communication module 2013 and the like.

A driver support system unit 2030 comprises various devices such as a millimeter wave radar, a Light Detection and Ranging (LiDAR), a camera, a positioning locator (for example, GNSS), map information (for example, high-definition (HD) maps, autonomous vehicle (AV) maps, and the like), a gyroscopic system (for example, an Inertial Measurement Unit (IMU), an Inertial Navigation System (INS), and the like), an Artificial Intelligence (AI) chip, and an AI processor for providing functions to prevent accidents or reduce a driving load of a driver, and one or more ECUs for controlling these devices. Further, the driver support system unit 2030 transmits and receives various kinds of information through the communication module 2013 to realize a driver support function or an automatic driving function.

The communication module 2013 can communicate with the microprocessor 2031 and components of the vehicle 1 through a communication port. For example, the communication module 2013 transmits and receives data through the communication port 2033 to and from the drive 2002, steering 2003, accelerator pedal 2004, brake pedal 2005, shift lever 2006, left and right front wheels 2007, left and right rear wheels 2008, axle 2009, microprocessor 2031 in the electronic control 2010, memory (ROM, RAM) 2032, and sensor 2021 to 2028.

The communication module 2013 is a communication device that can be controlled by the microprocessor 2031 of the electronic controller 2010 and can communicate with an external device. For example, The communication module 2013 transmits and receives various kinds of information via radio communication with the external device. The communication module 2013 may be placed inside or outside the electronic control unit 2010. Examples of the external device may include a base station, a mobile station, and the like.

The communication module 2013 transmits a current signal coming from a current sensor and input to the electronic controller 2010 to an external device via radio communication. Further, the communication module 2013 transmits a rotation speed signal of a front wheel and a rear wheel acquired by the speed sensor 2022, a pressure signal of a front wheel and a rear wheel acquired by an air pressure sensor 2023, a speed signal of a vehicle acquired by a speed sensor 2024, an acceleration signal acquired by an acceleration sensor 2025, an accelerator pedal pressed-amount signal acquired by an accelerator pedal sensor 2029, a brake pedal pressed-amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like input to the electronic controller 2010 to an external device via radio communication.

The communication module 2013 receives various information (traffic information, signal information, inter-vehicle information, and the like.) transmitted from the external device and displays on the information service unit 2012 provided in the vehicle. Further, the communication module 2013 stores various information received from the external device in a memory 2032 usable by the microprocessor 2031. Based on the information stored in the memory 2032, the microprocessor 2031 may control the drive 2002, the steering 2003, the accelerator pedal 2004, the brake pedal 2005, the shift lever 2006, the left and right front wheels 2007, the left and right rear wheels 2008, the axle 2009, the sensors 2021 to 2028, and the like. provided in the vehicle 2001.

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 Radio communication system
20 NG-RAN
100 NodeB
200 UE
210 Radio signal transmission and reception unit
220 Amplifier unit
230 Modulation and demodulation unit
240 Control signal and reference signal processing unit
250 Encoding/decoding unit
260 Data transmission and reception unit
270 Control unit
1001 Processor
1002 Memory
1003 Storage
1004 Communication device
1005 Input Device
1006 Output device
1007 Bus
2001 Vehicle
2002 Drive
2003 Steering
2004 Axel pedal
2005 Brake pedal
2006 Shift lever
2007 Left and right front wheels
2008 Left and right rear wheels
2009 Axle
2010 Electronic controller
2012 Information service unit
2013 Communication module
2021 Current sensor
2022 Speed sensor
2023 Air pressure sensor
2024 Vehicle speed sensor
2025 Acceleration sensor
2026 Brake pedal sensor
2027 Shift lever sensor
2028 Object detection sensor
2029 Axel pedal sensor
2030 Operation support system
2031 Microprocessor
2032 Memory (ROM, RAM)
2033 Communication port

1. A radio base station comprising:
a control unit that performs a beam search with a plurality of stages in which at least any of a beam width to be searched and the number of beam candidates to be searched is different; and
a transmission and reception unit that transmits and receives data at a required rate, wherein
the control unit performs the beam search including a first stage and a second stage after an end of the first stage having a beam width that is narrower than a beam width of the first stage and the number of beam candidates that is larger than the number of beam candidates of the first stage, and
the transmission and reception unit starts transmitting and receiving the data immediately after the end of the first stage, when the required rate is a specified rate or less, and starts transmitting and receiving the data after an end of the second stage, when the required rate is more than the specified rate.

2. A radio base station comprising:
a control unit that performs a beam search with a plurality of stages in which at least any of a beam width to be searched and the number of beam candidates to be searched is different, wherein
the control unit performs the beam search including a first stage and a second stage after an end of the first stage having a beam width that is narrower than a beam width of the first stage and the number of beam candidates that is larger than the number of beam candidates of the first stage, and
the control unit performs scheduling of a user in the first stage or the second stage.

3. The radio base station according to claim 1, wherein
the control unit changes the beam width or the number of beam candidates according to the required rate or the number of users.

4. The radio base station according to claim 1, wherein
the control unit changes at least any of the order of a search direction of a beam and a frequency band to be searched in the first stage or the second stage.

5. A terminal comprising:
a control unit that performs a beam search with a plurality of stages in which at least any of a beam width to be searched and the number of beam candidates to be searched is different; and
a transmission and reception unit that transmits and receives data at a required rate, wherein
the control unit performs the beam search including a first stage and a second stage after an end of the first stage having a beam width that is narrower than a beam width of the first stage and the number of beam candidates that is larger than the number of beam candidates of the first stage, and
the transmission and reception unit starts transmitting and receiving the data immediately after the end of the first stage, when the required rate is a specified rate or less, and starts transmitting and receiving the data after an end of the second stage, when the required rate is more than the specified rate.

6. A terminal comprising:
a control unit that performs a beam search with a plurality of stages in which at least any of a beam width to be searched and the number of beam candidates to be searched is different, wherein
the control unit performs the beam search including a first stage and a second stage after an end of the first stage having a beam width that is narrower than a beam width of the first stage and the number of beam candidates that is larger than the number of beam candidates of the first stage, and
the control unit performs scheduling of a user in the first stage or the second stage.

7. The radio base station according to claim 2, wherein
the control unit changes at least any of the order of a search direction of a beam and a frequency band to be searched in the first stage or the second stage.
